(19) United States
(12) Patent Application Publication
(10) Pub. No.: US 2023/0084990 A1
(43) Pub. Date: Mar. 16, 2023

(54) PORTABLE FIRE EXTINGUISHER OPERATED WITH A BUTTON ON THE EXTERNAL SURFACE

(71) Applicant: Carrier Corporation, Palm Beach Gardens, FL (US)

(72) Inventors: Weina Li, Acton, MA (US); Christopher Fergusson, Haw River, NC (US); Slade Culp, Coventry, CT (US)

(21) Appl. No.: 17/942,724

(22) Filed: Sep. 12, 2022

Related U.S. Application Data
(60) Provisional application No. 63/243,393, filed on Sep. 13, 2021.

(51) Int. Cl. A62C 13/76; A62C 13/64

(52) U.S. Cl. CPC A62C 13/76; A62C 13/64

(57) ABSTRACT

A fire extinguisher includes a cylinder for storing a fire extinguishing agent; a valve assembly disposed on the cylinder, the valve assembly comprising a closed position and an open position, the valve assembly configured to deliver the fire extinguishing agent from within the cylinder when in the open position; and an actuation assembly operably connected to the valve assembly, the actuation assembly comprising a button and a control device, the control device configured to actuate the valve assembly from the closed position to the open position when the button is contacted.

### CROSS-REFERENCE TO RELATED APPLICATIONS

This application claims the benefit of Provisional Application No. 63/243,393, filed Sep. 13, 2021, the disclosure of which is incorporated herein by reference in its entirety.

### BACKGROUND

Exemplary embodiments pertain to the art of portable fire extinguishers.

A portable fire extinguisher typically includes a pin, a hand-held handle, a nozzle, and a cylinder containing a fire extinguishing agent. In the event of a fire, printed instruction on the portable fire extinguisher guides the user through the sequential steps to discharge the fire extinguishing agent. Although the instruction is written in plain language or diagrams, users may have difficulty using the portable fire extinguisher due to many factors. For example, users, particularly first time users, may not have enough time in the event of a fire to quickly read the instruction to use the portable fire extinguisher.

### BRIEF DESCRIPTION

In accordance with an embodiment, a fire extinguisher includes a cylinder for storing a fire extinguishing agent; a valve assembly disposed on the cylinder, the valve assembly comprising a closed position and an open position, the valve assembly configured to deliver the fire extinguishing agent from within the cylinder when in the open position; and an actuation assembly operably connected to the valve assembly, the actuation assembly comprising a button and a control device, the control device configured to actuate the valve assembly from the closed position to the open position when the button is contacted.

In addition to one or more of the features described herein, or as an alternative, further embodiments may include wherein the button is disposed on one of: a radially outward facing surface of the cylinder, a radially outward facing surface of the valve assembly, and the top of the cylinder.

In addition to one or more of the features described herein, or as an alternative, further embodiments may include wherein the actuator assembly further comprises a power supply in operable communication with the control device, the power supply configured to provide electrical power to the control device when the button is contacted.

In addition to one or more of the features described herein, or as an alternative, further embodiments may include wherein the button comprises a contact sensor, the contact sensor configured to activate the control device when a threshold amount of force of contact on the button is identified.

In addition to one or more of the features described herein, or as an alternative, further embodiments may include wherein the power supply is a rechargeable or disposable battery, the control device utilizing at least a portion of the electrical power from the power supply to mechanically actuate the valve assembly.

In addition to one or more of the features described herein, or as an alternative, further embodiments may wherein the control device is programmed to control the open and close position of the valve assembly in proportion to the amount of force of contact applied to the button.

In addition to one or more of the features described herein, or as an alternative, further embodiments may include wherein the control device electro-pneumatically actuates the valve assembly.

In accordance with another embodiment, a method of operating a fire extinguisher, the fire extinguisher including a cylinder for storing a fire extinguishing agent, a valve assembly disposed on the cylinder, and an actuation assembly operably connected to the valve assembly, the actuation assembly comprising a button and a control device, the method including detecting contact with the button, the button operably connected with the control device; and actuating, using the control device, the valve assembly from a closed position to an open position, the valve assembly configured to deliver the fire extinguishing agent from within the cylinder when in the open position.

In addition to one or more of the features described herein, or as an alternative, further embodiments may include wherein the button is disposed on one of: a radially outward facing surface of the cylinder, a radially outward facing surface of the valve assembly, and the top of the cylinder.

In addition to one or more of the features described herein, or as an alternative, further embodiments may include wherein the actuator assembly further comprises a power supply in operable communication with the control device, the power supply configured to provide electrical power to the control device when the button is contacted.

In addition to one or more of the features described herein, or as an alternative, further embodiments may include wherein the button comprises a contact sensor, the contact sensor configured to activate the control device when a threshold amount of force of contact on the button is identified.

In addition to one or more of the features described herein, or as an alternative, further embodiments may include wherein the power supply is a rechargeable or disposable battery, the control device utilizing at least a portion of the electrical power from the power supply to mechanically actuate the valve assembly.

In addition to one or more of the features described herein, or as an alternative, further embodiments may include wherein the control device is programmed to control the open and close position of the valve assembly in proportion to the amount of force of contact applied to the button.

In addition to one or more of the features described herein, or as an alternative, further embodiments may include wherein the control device electro-pneumatically actuates the valve assembly.

In addition to one or more of the features described herein, or as an alternative, further embodiments may include wherein the control device maintains the valve assembly in the closed position before contact with the button is detected.

Technical effects of embodiments of the present disclosure include providing a fire extinguisher with simplified mechanism for operation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### DESCRIPTION OF THE DRAWINGS

The following descriptions should not be considered limiting in any way. With reference to the accompanying drawings, like elements are numbered alike.

FIG. 1 is a perspective view of a fire extinguisher equipped with a button on the top of a cylinder in an example embodiment.

FIG. 2 is a perspective view of a fire extinguisher equipped with a button on a handle in an example embodiment.

FIG. 3 is a perspective view of a fire extinguisher equipped with a button on the side of a cylinder in an example embodiment.

FIG. 4 is an exploded view of a fire extinguisher equipped with a button in an example embodiment.

### DETAILED DESCRIPTION

A detailed description of one or more embodiments of the disclosed apparatus and method are presented herein by way of exemplification and not limitation with reference to the Figures.

An actuation assembly for convenient use, compared to conventional actuation assembly (e.g., which commonly involves pulling a pin or squeezing a hand-held handle of a fire extinguisher), a fire extinguisher incorporating the actuation assembly, and a method for operating the actuation assembly to allow the passage of at least one fluid (e.g., a fire extinguishing agent) are provided. The actuation assembly described herein may be particularly useful for reducing complexity, which may help increase, or at least allow, to operate the fire extinguisher in time. It should be appreciated that, because a button of the actuation assembly is placed on the surface of the fire extinguisher, users may operate the fire extinguisher immediately in the event of a fire without training. It should be appreciated that the fire extinguisher's portability may help increase, or at least allow, users, including infirm people and children, to carry and operate the fire extinguisher.

Disclosed herein is a portable fire extinguisher that includes a cylinder that stores a fire extinguishing agent, a valve assembly, having a closed and an open position, disposed on the cylinder, and configured to deliver fire extinguishing agent from within the cylinder, an actuation assembly operably connected to the valve assembly, the actuation assembly including a button and a control device.

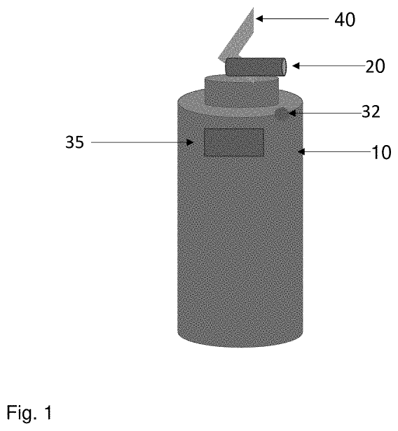

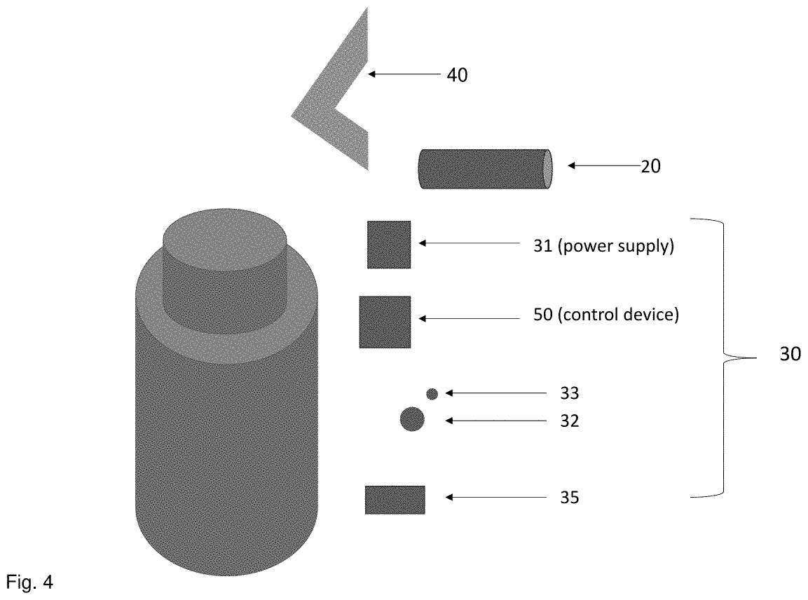

With reference now to the Figures, a perspective view of the fire extinguisher, in accordance with various aspects of the disclosure, is shown in FIG. 1. As shown in FIG. 1, the fire extinguisher includes a cylinder 10 that stores a fire extinguishing agent. A valve assembly 20 is disposed on the neck portion of the cylinder 10. An actuation assembly 30 (FIG. 4) includes a power supply 31, a button 32, a contact sensor 33, a display 35 and a control device 50. The actuation assembly 30 is operably connected to the valve assembly 20, and a handle 40 disposed on the neck portion of the cylinder. A nozzle hose may be connected to the valve assembly 20 in example embodiments.

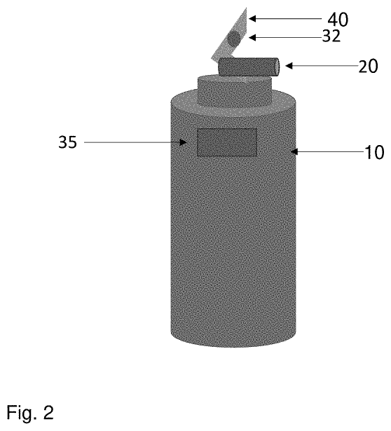

FIG. 2 depicts a fire extinguisher in an alternate embodiment, in which the button 32 is placed on the handle 40.

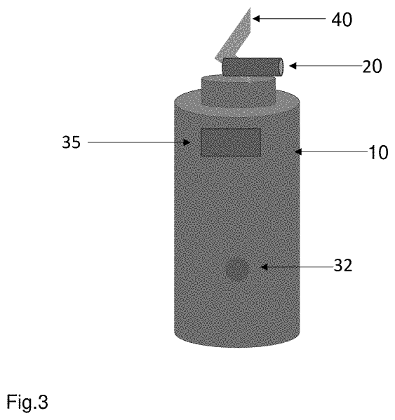

FIG. 3 depicts a fire extinguisher in another alternate embodiment, in which the button 32 is placed on the side of the cylinder 10.

In FIGS. 1-3, the button 32 of the actuation assembly 30 is disposed on the top or side of the cylinder 10 or the handle 40. It is understood that the button 32 may be located in other areas, and embodiments are not limited to the locations of button 32 in FIGS. 1-3. The button 32 may include a protective cover to prevent inadvertent activation of the button.

FIG. 4 is an exploded view of a fire extinguisher equipped with a button 32 in an example embodiment. The fire extinguisher includes an actuation assembly 30, that may extend circumferentially around the fire extinguisher, or at least a portion of the radially outward facing surface of the cylinder based on the need for residential or commercial areas.

The actuation assembly 30 includes a power supply 31 and control device 50, in addition to the button 32 and the display 35. The control device 50 may be implemented using a circuit board, a microprocessor, ASIC, FPGA, etc., configured to perform the operations described herein. The display 35 may be an LCD display and provide information such as battery level, amount of fire extinguishing agent, operating instructions, etc. Operating instructions may also be printed on the fire extinguisher.

The actuation assembly 30 is configured to enable the communication with the valve assembly 20. The button 32 is disposed on a radially outward facing surface of a contact sensor 33 that is configured to be connected to the control device 50. The power supply 31 may include rechargeable or disposable batteries to enable the operation of the actuation assembly 30. The control device 50 may be disposed on a radially inward facing inner surface of the cylinder 10 or radially outward facing the cylinder's outer surface 10.

Tactile input upon the button 32 is transferred to the contact sensor 33. The contact sensor 33 provides a signal to the control device 50. The signal may be indicative of the amount of force of contact on the button 32. The power supply 31 may be connected to an input of the control device 50 through the contact sensor 33. The contact sensor 33 may require a threshold amount of force of contact on the button 32 prior to sending a signal to the control device 50. This prevents inadvertent opening of the valve assembly 20. The control device 50 may be programmed to direct the open and close position of the valve assembly 20 in proportion to the amount of force of contact on the button 32. The button 32 is configured to recognize a tactile input of a user when wearing gloves.

The contact sensor 33 may be programmed with fingerprint recognition to allow certain users to activate the onset of the primary mechanism.

In response to tactile input upon the button 32, the control device 50 directs the valve assembly 20 to an open to allow passage of a fire extinguishing agent in cylinder 10 through the valve assembly 20. The control device 50 may electro-pneumatically actuates the valve assembly 20. For example, the valve assembly 20 may include a solenoid that opens or closes a valve in response to an electrical signal from the control device 50. Other types of electrically controlled valves may be used in the valve assembly 20. At least a portion of the electrical power from the power supply 31 is used to mechanically actuate the valve assembly 20. The control device 50 may be programmed with an electronic lockout to open the valve assembly 20 only after the occurrence of tactile input at the button 32. The valve assembly 20 may be normally closed, and opened only in response to the presence of a signal from the control device 50.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fire extinguisher comprising:
a cylinder for storing a fire extinguishing agent;
a valve assembly disposed on the cylinder, the valve assembly comprising a closed position and an open position, the valve assembly configured to deliver the fire extinguishing agent from within the cylinder when in the open position; and
an actuation assembly operably connected to the valve assembly, the actuation assembly comprising a button and a control device, the control device configured to actuate the valve assembly from the closed position to the open position when the button is contacted.

2. The fire extinguisher of claim 1, wherein the button is disposed on one of: a radially outward facing surface of the cylinder, a radially outward facing surface of the valve assembly, and the top of the cylinder.

3. The fire extinguisher of claim 1, wherein the actuator assembly further comprises a power supply in operable communication with the control device, the power supply configured to provide electrical power to the control device when the button is contacted.

4. The fire extinguisher of claim 1, wherein the button comprises a contact sensor, the contact sensor configured to activate the control device when a threshold amount of force of contact on the button is identified.

5. The fire extinguisher of claim 3, wherein the power supply is a rechargeable or disposable battery, the control device utilizing at least a portion of the electrical power from the power supply to mechanically actuate the valve assembly.

6. The fire extinguisher of claim 4, wherein the control device is programmed to control the open and close position of the valve assembly in proportion to the amount of force of contact applied to the button.

7. The fire extinguisher of claim 5, wherein the control device electro-pneumatically actuates the valve assembly.

8. A method of operating a fire extinguisher, the fire extinguisher comprising a cylinder for storing a fire extinguishing agent, a valve assembly disposed on the cylinder, and an actuation assembly operably connected to the valve assembly, the actuation assembly comprising a button and a control device, the method comprising:
detecting contact with the button, the button operably connected with the control device; and
actuating, using the control device, the valve assembly from a closed position to an open position, the valve assembly configured to deliver the fire extinguishing agent from within the cylinder when in the open position.

9. The method of claim 8, wherein the button is disposed on one of: a radially outward facing surface of the cylinder, a radially outward facing surface of the valve assembly, and the top of the cylinder.

10. The method of claim 8, wherein the actuator assembly further comprises a power supply in operable communication with the control device, the power supply configured to provide electrical power to the control device when the button is contacted.

11. The method of claim 13, wherein the button comprises a contact sensor, the contact sensor configured to activate the control device when a threshold amount of force of contact on the button is identified.

12. The method of claim 10, wherein the power supply is a rechargeable or disposable battery, the control device utilizing at least a portion of the electrical power from the power supply to mechanically actuate the valve assembly.

13. The method of claim 11, wherein the control device is programmed to control the open and close position of the valve assembly in proportion to the amount of force of contact applied to the button.

14. The method of claim 8, wherein the control device electro-pneumatically actuates the valve assembly.

15. The method of claim 8, wherein the control device maintains the valve assembly in the closed position before contact with the button is detected.
